(19) United States
(12) Patent Application Publication
(10) Pub. No.: US 2004/0244498 A1
(43) Pub. Date: Dec. 9, 2004

(54) Fluid flow meter with fluid flow sensor and oscillation sensor

(75) Inventors: Shiang-Fu Chen, Hsinchu (TW); Shyh-Chyi Kuo, Yangmei Jen (TW)

Correspondence Address: SHAW PITTMAN, IP GROUP, 1650 TYSONS BOULEVARD, SUITE 1300, MCLEAN, VA, 22102, US

(73) Assignee: INDUSTRIAL TECHNOLOGY RESEARCH INSTITUTE

(21) Appl. No.: 10/456,389

(22) Filed: Jun. 6, 2003

(51) Int. Cl. G01F 1/20

(52) U.S. Cl. 73/861.19

(57) ABSTRACT

A new and improved fluid flow meter which is suitable for a variety of industrial and mechanical applications. The fluid flow meter includes a fluid flow sensor that detects fluid flowing at low rates and a fluid oscillation sensor that detects fluid flowing at high rates through the sensor. The combined use of a fluid flow sensor and a fluid oscillation sensor enables the fluid flow meter to measure fluid flow rates over a broad range.

### FIELD OF THE INVENTION

The present invention relates to flow meters for measuring the rate of flow of a fluid through a vessel. More particularly, the present invention relates to a new and improved fluid flow meter which includes both a fluid oscillation sensor and a fluid flow sensor to provide fluid flow measurement capabilities over a broad range while minimizing loss of fluid pressure.

### BACKGROUND OF THE INVENTION

Flow meters are widely used in a variety of industries for measuring the rate of flow of fluids through a vessel. For example, breathing devices used in hospitals, car air conditioners, and household gas meters utilize gas meters. However, most fluid flow meters known in the art are capable of measuring fluid flow rates only over a narrow range. Moreover, these fluid flow meters are not suitable for measuring the rate of flow of fluids through a micro-sized channel. There currently exists no wire-type sensor fluid flow meter which is capable of measuring fluid flow rates over a dynamic range of 10,000:1.

Flow meters having various structures and designs are known in the art. U.S. Pat. No. 4,224,230 discloses a fluidic oscillation flow meter. The flow meter exploits the Coanda effect, in which a main fluid jet collides with a concave wall or sink, producing an unstable or turbulent fluid oscillation effect. Thus, the oscillation effect is directly proportional to the flow resistance, and this requires a substantial pressure drop between the inlet and outlet ends of the meter for proper functioning of the meter.

Another flow meter which operates under the Coanda effect is disclosed in U.S. Pat. No. 5,396,809. That flow meter includes an array of sensors disposed in an oscillation sink that is placed in direct contact with the flowing fluid. The flow meter improves and enhances measurement accuracy for fluids having a low rate of flow.

U.S. Pat. No. 5,363,704 discloses a flow meter which includes converging flow channels with a central oscillation sink disposed in direct contact with the flowing fluid. When the rate of flow of the fluid through the flow channels increases, the oscillation effect is improved although the turbulence of the fluid in the oscillation sink increases. To remedy this effect and increase the signal/noise ratio of the signals measured by oscillation sensors in the oscillation sink, channels extend from the oscillation sink and communicate with the separate flow channels to permit flow of the fluid from the oscillation sink to the channels. This increases the signal/noise ratio of the sensor signals.

U.S. Pat. No. 5,157,974 discloses a fluidic flow meter which is suitable for mini-microcomputer technologies. In the flow meter, a flow sensor is placed at the outlet of the flow channel. When fluid flows through the channel, the fluid oscillates. A signal amplifier measures the signal and calculates flow speed and then converts the flow speed to flow volume. While this configuration prevents a decrease in the signal/noise ratio when oscillation of the fluid occurs, the oscillation signal is attenuated.

Japanese Pat. no. JP44-262209 discloses a flow meter having a design which is similar to that of U.S. Pat. No. 5,157,974, except that an oscillation frequency sensor is placed at the inlet of an oscillation chamber to increase the sensor oscillation frequency. However, the sensor has a tendency to inaccurately interpret the oscillation signal when the upstream fluid pressure changes.

Japanese Pat. no. JP2001-208575 discloses another flow meter which operates according to the Coanda effect. The fluid inlet channel of the flow meter gradually narrows to accelerate the fluid, then passes through a short channel and into an oscillation chamber having an oscillation sensor. Like the flow meter of JP44-262209, the sensor has a tendency to inaccurately interpret the oscillation signal when the upstream fluid pressure changes.

An object of the present invention is to provide a new and improved fluid flow meter which avoids the drawbacks of conventional fluid flow meters.

Another object of the present invention is to provide a new and improved fluid flow meter which has broad mechanical and industrial application.

Still another object of the present invention is to provide a new and improved fluid flow meter which combines a fluid oscillation sensor and a fluid flow sensor to impart fluid flow rate measurement capability over a broad range.

Yet another object of the present invention is to provide a new and improved fluid flow meter which enhances fluid oscillation while preventing or substantially minimizing drop in fluid pressure through the fluid flow meter.

A still further object of the present invention is to provide a new and improved fluid flow meter which is capable of accurate measurement over prolonged use.

Yet another object of the present invention is to provide a new and improved fluid flow meter which is self-cleaning.

A still further object of the present invention is to provide a new and improved fluid flow meter which may include an oscillation chamber and one or a pair of fluid flow feedback channels which extend from the downstream end to the upstream end of the oscillation chamber to enhance oscillation of a fluid in the oscillation chamber.

### SUMMARY OF THE INVENTION

In accordance with these and other objects and advantages, the present invention is generally directed to a new and improved fluid flow meter which is suitable for a variety of industrial and mechanical applications. The fluid flow meter includes a fluid flow sensor that detects fluid flowing at low rates and a fluid oscillation sensor that detects fluid flowing at high rates through the sensor. The combined use of a fluid flow sensor and a fluid oscillation sensor enables the fluid flow meter to measure fluid flow rates over a broad range.

The fluid flow meter may include an oscillation chamber and at least one feedback fluid flow channel which has an inlet end at the downstream end of the oscillation chamber and an outlet end at the upstream end of the oscillation chamber. The oscillation sensor may be a single-wire flow oscillation sensor that is placed in the feedback flow channel.

The oscillation chamber of the fluid flow meter may gradually narrow from the outlet end to the inlet end of the feedback fluid flow channel, or from the upstream end to the downstream end of the oscillation chamber. This tapered configuration of the oscillation chamber facilitates oscillation of the flowing fluid at a relatively low fluid flow rate. Alternatively or in addition, the inlet end of the feedback fluid flow channel may be enlarged to enhance oscillation of the fluid flowing through the oscillation chamber.

The oscillation sensor may be a single-wire oscillation sensor, whereas the fluid flow sensor may be a multiple-wire fluid flow sensor. The fluid flow sensor may include a sensor housing, a heating element provided in the sensor housing adjacent to an inlet end, and multiple, spaced-apart thermal sensors provided in the sensor housing downstream of the heating element. The fluid flow sensor utilizes a “time of flight” method to determine the rate of flow of the fluid through the sensor housing. Electric energy is intermittently applied to the heating element, which heats the fluid flowing against the heating element. Flow rate of the fluid is calculated by dividing the distance between the heating element and the sensors by the time which elapses between heating of the fluid at the heating element and thermal detection by the thermal sensors.

### BRIEF DESCRIPTION OF THE DRAWINGS

The invention will now be described, by way of example, with reference to the accompanying drawings, in which:

FIG. 1 is a side view of an illustrative embodiment of the fluid flow meter of the present invention;

FIG. 2 is a longitudinal sectional view, taken along section lines 2-2 in FIG. 1, of the fluid flow meter;

FIG. 2A is a sectional view of a portion of another embodiment of the fluid flow meter of the present invention;

FIG. 3 is a longitudinal sectional view illustrating interior elements of a fluid flow sensor component of the fluid flow meter;

FIG. 4 is an exploded, perspective view of the fluid flow meter;

FIG. 5 is a longitudinal sectional view illustrating interior elements of a typical fluid-flow oscillation sensor component of the fluid flow meter;

FIG. 6 is an enlarged view of the oscillation chamber, feedback fluid flow channels, and sensor elements of the fluid flow meter, more particularly detailing a typical flow path of a fluid through those elements of the fluid flow meter in operation of the invention; and

FIG. 7 illustrates an alternative configuration for the feedback fluid flow channels and oscillation chamber of the fluid flow meter.

### DESCRIPTION OF THE PREFERRED EMBODIMENTS

Shown throughout the drawings, the present invention is generally directed to a new and improved fluid flow meter which is capable of measuring rates of flow of fluids across a broad flow rate range. The fluid flow meter includes a fluid flow sensor that detects fluid flowing at low rates and a fluid oscillation sensor that detects fluid flowing at high rates through the sensor. The fluid flow meter is suitable for a variety of industrial and mechanical applications, including but not limited to gas meters or other fluid meter system tools, medical devices, vehicle air controllers, mass flow controllers or micro-flow controllers in micro device technologies.

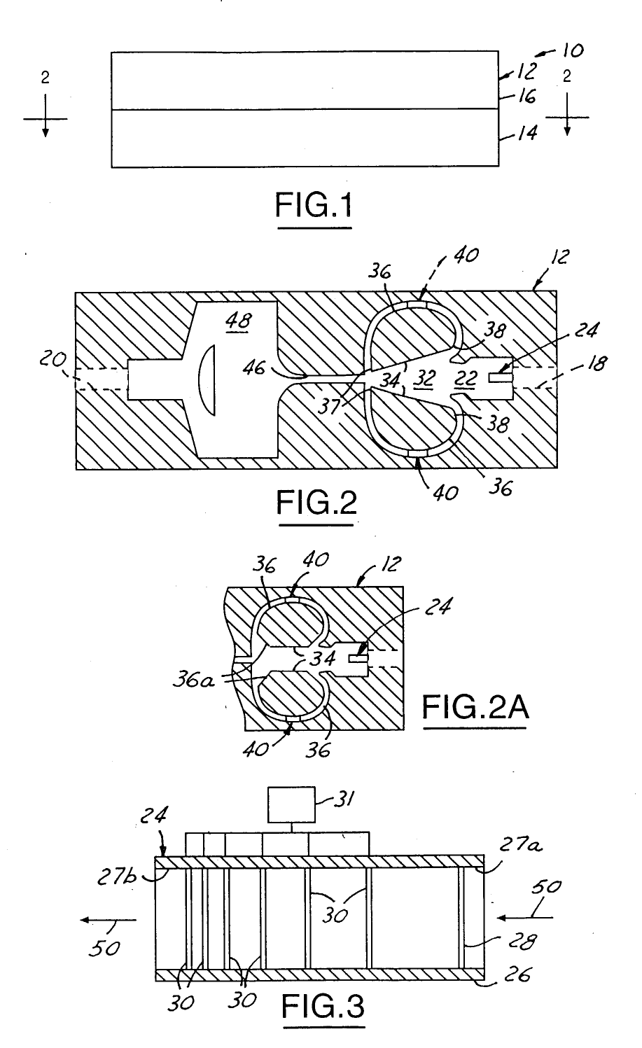

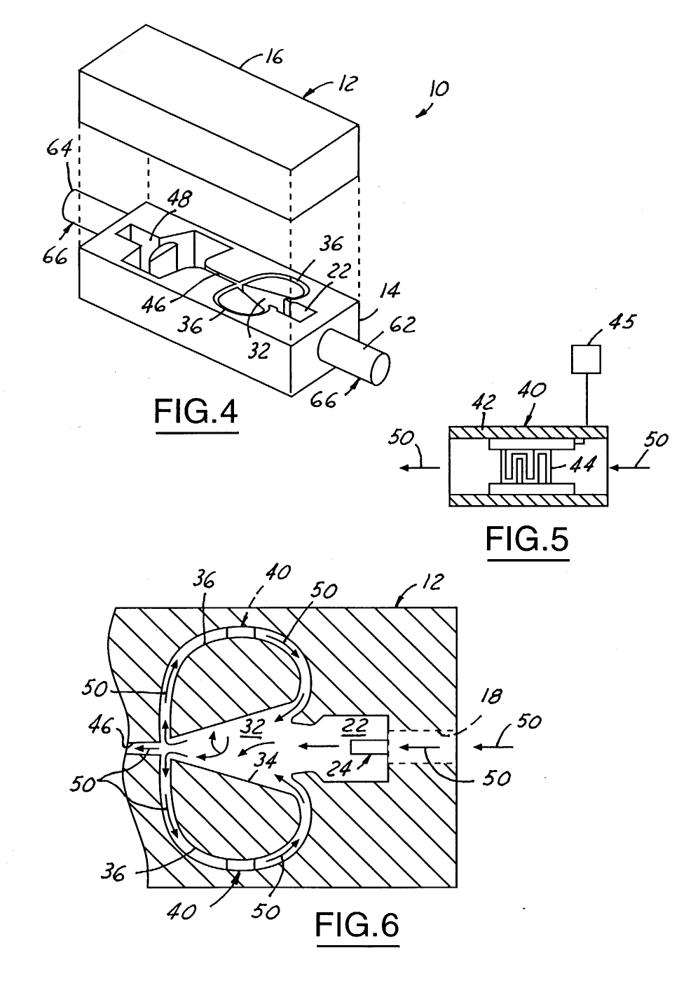

Referring initially to FIGS. 1-5, an illustrative embodiment of the fluid flow meter of the present invention is generally indicated by reference numeral 10. The fluid flow meter 10 includes a housing 12 which may have a base portion 14 to which is mounted a top portion 16, as shown in FIG. 4. Alternatively, it is understood that the housing 12 may have a unitary construction. As shown in FIG. 2, a fluid flow inlet 18 and a fluid flow outlet 20 are provided at respective ends of the housing 12. As further shown in FIG. 2, the fluid flow inlet 18 may communicate with an inlet chamber 22, in which is typically provided a fluid flow sensor 24, the details of which will be hereinafter described. An oscillation chamber 32 in the housing 12 communicates with the inlet chamber 22. At least one, and preferably, two feedback fluid flow channels 36 further extend through the housing 12 on opposite sides of the oscillation chamber 32. The inlet end 37 of each feedback fluid flow channel 36 is located at the downstream end of the oscillation chamber 32. Each channel 36 arcs back through the housing 12, and the outlet end 38 of each channel 36 communicates with the upstream end of the oscillation chamber 32. In a preferred embodiment, as shown in FIG. 2, the chamber walls 34 of the oscillation chamber 32 gradually narrow or taper inwardly from the outlet end 38 to the inlet end 37 of each channel 36. In an alternative embodiment, shown in FIG. 2A, the chamber walls 34 may be substantially parallel and the inlet end of each channel 36 is enlarged to define an inlet mouth 36a. In each embodiment, a fluid oscillation sensor 40, the details of which will be hereinafter described, is provided in one or both of the channels 36 for purposes which will be hereinafter described.

As further shown in FIG. 2, an outlet chamber 48 may communicate with the downstream end of the oscillation chamber 32 through an outlet flow channel 46 which extends through the housing 12. The fluid flow outlet 20 extends from the outlet chamber 48, through the housing 12 and communicates with the exterior of the housing 12.

As shown in FIG. 3, the fluid flow sensor 24 of the fluid flow meter 10 is preferably a multi-wire type of micro flow sensor and includes a sensor housing 26 having an inlet end 27a and an outlet end 27b. A heating element 28 spans the interior of the housing 26 adjacent to the inlet end 27a, and multiple thermal sensor wires 30 likewise span the interior of the housing 26 at selected spacings with respect to each other and with respect to the heating element 28. The heating element 28 is preferably a polysilicon heater/thermistor. Each of the thermal sensor wires 30 is connected to a flow rate calculating device 31, which includes a fluidic flow meter logic circuit to calculate the flow rate of the fluid, as hereinafter described. The circuit may include the capability to formulate and display the flow rate of the fluid in the form of a “yes/no” answer, with “yes” indicating positive flow of the fluid and “no” indicating little or no flow of the fluid. In operation of the fluid flow meter 10 as hereinafter described, a fluid 50 flows through the sensor housing 26, from the inlet end 27a to the outlet end 27b. An electrical current is intermittently applied to the heating element 28, which heats the flowing fluid 50. The heated fluid 50 then successively contacts the respective thermal sensors 30. Accordingly, the flow rate calculating device 31 calculates the flow rate of the fluid 50 by dividing the distance between the heating element 28 and each successive thermal sensor wire 30, by the time required for the heated fluid 50 to traverse the distance between the heating element 28 and the corresponding thermal sensor wire 30. It is understood that the fluid flow sensor 24 heretofore described represents just one example of a fluid flow meter which is suitable for implementation of the present invention, and that any type of fluid flow meter which is capable of measuring the flow rate of a fluid flowing therethrough may be used instead.

As shown in FIG. 5, the fluid oscillation sensor 40 of the fluid flow meter 10 is preferably a single wire-type fluid oscillation sensor. Such a sensor may be conventional and includes an enclosure 42 having a single oscillation wire 44 which spans the interior of the housing 42 in multiple passes. Accordingly, a turbulent or oscillating fluid 50 flowing through the enclosure 42 contacts and oscillates the oscillation wire 44, which provides this information to an oscillation measuring device 45 connected thereto to determine the degree of oscillation or turbulence of the fluid 50, as is known by those skilled in the art. The oscillation measuring device 45 includes flow calculation logic circuit which converts the period oscillation frequency of the oscillation wire 44, under influence by the oscillating fluid 50, to instant flow speed of the fluid 50, as is known by those skilled in the art.

Referring next to FIGS. 2, 4 and 6, in operation the fluid flow meter 10 is installed in a fluid flow line 66 by connecting a fluid inlet conduit 62 to the fluid flow inlet 18 and a fluid outlet conduit 64 to the fluid flow outlet 64 of the housing 12. As shown in FIG. 6, a fluid 50, which may be a gas or a liquid, flows from the fluid inlet conduit 62, through the fluid flow sensor 24 in the inlet chamber 22 of the housing 12, into the oscillation chamber 32, through the outlet flow channel 46 and outlet chamber 48, and from the housing 12 through the fluid flow outlet 20 and fluid outlet conduit 64 of the fluid flow line 66, respectively.

When the fluid 50 flows at a relatively low flow rate of typically about 1.5 m/s or less, little or no fluid oscillation occurs in the oscillation chamber 32 or feedback fluid flow channels 36. Accordingly, the fluid flow sensor 24, rather than the fluid oscillation sensor or sensors 40, is used to measure the flow rate of the fluid 50 at these relatively low flow speeds. An electrical current is intermittently applied to the heating element 28, thereby heating the flowing fluid 50. As the heated fluid 50 flows into contact with the respective thermal sensors 30, the flow rate calculating device 31 calculates the flow rate of the fluid 50 by dividing the distance between the heating element 28 and each successive thermal sensor wire 30, by the time required for the heated fluid 50 to flow from the heating element 28 and each thermal sensor wire 30. This information may be displayed on a suitable display screen (not shown), for example, connected to the flow rate calculating device 31, as desired.

When the fluid 50 flows at a relatively high flow rate of typically greater than about 1.5 m/s, the fluid oscillation sensor or sensors 40, rather than the fluid flow sensor 24, is used to determine the flow rate of the fluid 50. Accordingly, at such relatively high fluid flow rates, some of the fluid 50 flowing through the oscillation chamber 32 enters the inlet end 37 of the feedback fluid flow channel or channels 36 and is distributed through the fluid oscillation sensor or sensors 40 therein. Each channel 36 distributes the fluid 50 back around to the upstream end of the oscillation chamber 32, where the fluid 50 exits the outlet end 38 of the channel 36 and pushes against the main stream of fluid 50 flowing from the inlet chamber 22 into the oscillation chamber 32. This causes oscillation of the fluid 50 in the oscillation chamber 32 and channels 36. The oscillation frequency of the oscillation sensor wire 44, produced by the oscillating fluid 50, is measured by the oscillation measuring device 45 (FIG. 5) connected to the fluid oscillation sensor 40. The oscillation measuring device 45 uses the period oscillation frequency produced by the oscillation sensor wire 44 to calculate instant flow speed via the flow calculation logic circuit, as is known by those skilled in the art. Accordingly, the fluid flow sensor 24 and the fluid oscillation sensor or sensors 40 are capable of detecting and measuring fluid flow rates over a broad range (on the order of about 10,000:1).

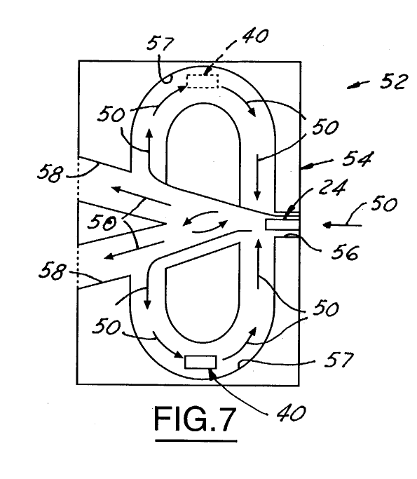

An alternative fluid flow configuration for a fluid flow meter 52 in another embodiment of the invention is shown in FIG. 7. The fluid flow meter 52 includes a housing 54 into which extends a fluid flow inlet 56 which receives the flowing fluid 50. An oscillation chamber 60 in the housing 54 gradually broadens from the fluid flow inlet 56 to a pair of outlet channels 58 which diverge from the oscillation chamber 60. At least one, and preferably, two feedback fluid flow channels 57 extend through the housing 54, from each outlet channel 58 to the upstream end of the oscillation chamber 60. A fluid oscillation sensor 40 is provided in one or both of the channels 57, and a fluid flow sensor 24 is provided typically in the fluid flow inlet 56. Accordingly, some of the flowing fluid 50 flows through the channels 57 and re-enters the oscillation chamber 60, thus causing oscillation of the main stream of fluid flowing from the fluid flow inlet 56, into the oscillation chamber 60. The fluid flow sensor 24 is used to calculate relatively low fluid flow rates (typically about 1.5 m/s or less), whereas the fluid oscillation sensor or sensors 40 are used to calculate relatively high fluid flow rates (typically greater than about 1.5 m/s), as heretofore described with respect to the embodiment of FIGS. 1-6.

While the preferred embodiments of the invention have been described above, it will be recognized and understood that various modifications can be made in the invention and the appended claims are intended to cover all such modifications which may fall within the spirit and scope of the invention.

1. A fluid flow meter comprising:
a housing for receiving a flowing fluid;
a fluid flow sensor provided in said housing;
an oscillation chamber provided in said housing for receiving the fluid;
an outlet flow channel provided in said housing in non-obstructed relationship to said oscillation chamber; and
an oscillation sensor provided in said housing.

2. The fluid flow meter of claim 1 further comprising at least one feedback fluid flow channel provided in said housing for receiving the fluid from said oscillation chamber and wherein said oscillation sensor is provided in said at least one feedback fluid flow channel.

3. The fluid flow meter or claim 2 wherein said oscillation chamber narrows in configuration from an upstream end to a downstream end of said oscillation chamber.

4. The fluid flow meter of claim 2 further comprising an inlet mouth provided on said at least one feedback fluid flow channel.

5. The fluid flow meter of claim 1 wherein said fluid flow sensor has a capability to formulate and display a flow rate of the fluid in the form of a “yes/no” answer, with “yes” indicating positive flow of the fluid and “no ” indicating no flow of the fluid.

6. The fluid flow meter of claim 5 further comprising at least one feedback fluid flow channel provided in said housing for receiving the fluid from said oscillation chamber and wherein said oscillation sensor is provided in said at least one feedback fluid flow channel.

7. The fluid flow meter of claim 6 wherein said oscillation chamber narrows in configuration from an upstream end to a downstream end of said oscillation chamber.

8. The fluid flow meter of claim 6 further comprises an inlet mouth provided oil said at least one feedback fluid flow channel.

9. The fluid flow meter of claim 1 wherein said said flow sensor comprises a housing having an inlet end and an outlet and, a heating element provided in said housing adjacent to said inlet end, and a plurality of thermal sensor wires provided in said housing in spaced-apart relationship to said heating element.

10. The fluid flow meter of claim 9 further comprising at least one feedback fluid flow channel provided in said housing for receiving the fluid from said oscillation chamber and wherein said oscillation sensor is provided in said at least one feedback fluid flow channel.

11. The fluid flow meter of claim 10 wherein said oscillation chamber narrows in configuration from an upstream end to a downstream end of said oscillation chamber.

12. The fluid flow meter of claim 10 further comprising and inlet mouth provided on said at least one feedback fluid flow channel.

13. A fluid flow meter comprising:
a housing for receiving a flowing fluid;
an oscillation chamber provided in said housing;
a fluid flow sensor provided in said housing upstream of said oscillation chamber for measuring low flow rates of the fluid;
at least one feedback fluid flow channel provided in said housing for diverting arid re-distributing a portion of the fluid from said oscillation chamber and back to said oscillation chamber;
an outlet flow channel provided in said housing in non-obstructed relationship to said oscillation chamber; and
all oscillation sensor provided in at least one of said feedback fluid flow channels for measuring high flow rates of the fluid.

14. The fluid flow meter of claim 13 wherein said oscillation chamber narrows from an upstream end to a downstream end of said oscillation chamber.

15. The fluid flow meter of claim 13 wherein said at least one feedback fluid flow chamber comprise a pair of feedback fluid flow channels.

16. The fluid flow meter of claim 15 wherein said oscillation chamber narrows from an upstream end to a downstream end of said oscillation chamber.

17. A fluid flow meter comprising:
a housing for receiving a flowing fluid;
an oscillation chamber provided in said housing;
a fluid flow sensor provided in said housing upstream of said oscillation chamber for measuring low flow rates of the fluid;
at least one feedback fluid flow channel provided in said housing for diverting and re-distributing a portion of the fluid from said oscillation chamber and back to said oscillation chambers said at least one fluid flow channel having an inlet mouth; and
an outlet flow chamber provided in said housing in non-obstructed relationship to said oscillation chamber; and an oscillation sensor provided in said at least one feedback flow channel for measuring high flow rates of the fluid.

18. The fluid flow meter of claim 17 wherein said oscillation chamber has subs substantially parallel chamber walls.

19. The fluid flow meter of claim 17 wherein said at least one feedback fluid flow channel comprises a pair of feedback fluid flow channels.

20. The fluid flow meter of claim 19 wherein said oscillation chamber has substantially parallel chamber walls.
